(19) United States
(12) Patent Application Publication
(10) Pub. No.: US 2025/0093928 A1
(43) Pub. Date: Mar. 20, 2025

(54) APPARATUSES, SYSTEMS, AND METHODS FOR POWER DELIVERY AND MANAGEMENT

(71) Applicant: NVIDIA CORPORATION, Santa Clara, CA (US)

(72) Inventor: David Paul Mohr, Houston, TX (US)

(21) Appl. No.: 18/370,127

(22) Filed: Sep. 19, 2023

(51) Int. Cl. G06F 1/26; H02J 7/00; H02J 7/34

(52) U.S. Cl. CPC G06F 1/263; H02J 7/0068; H02J 7/345

(57) ABSTRACT

Devices, apparatuses, systems, and methods for power delivery and management are provided. An example power delivery apparatus includes a first input electrically coupled with a first power source, an output electrically coupled with at least a first computing device, a primary power path electrically coupling the first input and the output, and a first energy storage path electrically coupling the first input and the output. The power delivery apparatus further includes an energy storage device electrically coupled with the first energy storage path that operates to store energy, and power supply units (PSUs) electrically coupled with the primary power path and the first energy storage path. The PSUs selectively route power received via the first input from the first power source to the primary power path for powering the first computing device or the first energy storage path for storage by the energy storage device.

### TECHNOLOGICAL FIELD

Example embodiments of the present disclosure relate generally to high-performance networking and computing systems and, more particularly, to devices and techniques for delivering and managing power to these systems.

### BACKGROUND

High-performance computing systems, such as those used in datacenters and other networking environments (e.g., datacom, telecom, and/or other similar data/communication transmission networks), may leverage numerous computing components (e.g., central processing units (CPUs), graphics processing units (GPUs), data processing units (DPUs), etc.) to perform the operations associated with these environments. The energy requirements associated with the performance of these operations by the computing components may vary dramatically such that the power supplied to these systems (e.g., via an electrical power grid or otherwise) may similarly vary. Applicant has identified a number of deficiencies and problems associated with conventional power delivery and management techniques. Through applied effort, ingenuity, and innovation, many of these identified problems have been solved by developing solutions that are included in embodiments of the present disclosure, many examples of which are described in detail herein.

### BRIEF SUMMARY

Devices, apparatuses, systems, and methods are provided for power delivery and management associated with high-performance computing components. With reference to an example power delivery apparatus, the apparatus may include a first input configured to be electrically coupled with a first power source, an output configured to be electrically coupled with at least a first computing device, a primary power path electrically coupling the first input and the output, and a first energy storage path electrically coupling the first input and the output. The example power delivery apparatus may further include an energy storage device electrically coupled with the first energy storage path and configured to store energy and one or more power supply units (PSUs) electrically coupled with the primary power path and the first energy storage path. The one or more PSUs may be configured to selectively route power received via the first input from the first power source to the primary power path for powering the first computing device or the first energy storage path for storage by the energy storage device.

In some embodiments, the one or more PSUs may further include a first PSU electrically coupled with the primary power path and a second PSU electrically coupled with the first energy storage path.

In some further embodiments, the first PSU may be configured to draw power from the first input so as to selectively route power to the first computing device via the primary power path and the second PSU may be configured to draw power from the first input so as to selectively route power to the energy storage device via the first energy storage path.

In some further embodiments, the first PSU and the second PSU may be configured to selectively route power via one or more proportional control operations.

In some embodiments, the first computing device may be a graphics processing unit (GPU).

In some embodiments, the energy storage device may include one or more of a battery, a supercapacitor, an ultracapacitor, a fuel cell, an alternate power grid connection, or a generator.

In some embodiments, the power delivery apparatus may further include a second input configured to be electrically coupled with a second power source, a secondary power path electrically coupling the second input and the output, and a second energy storage path electrically coupling the second input and the output. In such an embodiment, the one or more PSUs may be further electrically coupled with the second energy storage path and the secondary power path and configured to selectively route power received via the second input from the second power source to the secondary power path for powering the first computing device or the second energy storage path for storage by the energy storage device.

In some further embodiments, the one or more PSUs may further include a first PSU electrically coupled with the primary power path, a second PSU electrically coupled with the first energy storage path and the second energy storage path, and a third PSU electrically coupled with the secondary power path.

In some still further embodiments, the first PSU may be configured to draw power from the first input so as to selectively route power to the first computing device via the primary power path, and the third PSU may be configured to draw power from the second input so as to selectively route power to the first computing device via the secondary power path. In such an embodiment, the second PSU may be configured to draw power from the first input so as to selectively route power to the energy storage device via the first energy storage path and draw power from the second input so as to selectively route power to the energy storage device via the second energy storage path; and

In some further embodiments, the power delivery apparatus may further include a redundancy power path electrically coupling the first energy storage path and the second energy storage path.

In some still further embodiments, the one or more PSUs may be further configured to selectively route power received via the first input from the first power source to the secondary power path or the second energy storage path, or selectively route power received via the second input from the second power source to the primary power path or the first energy storage path.

In any embodiment, the power delivery apparatus may further include a housing defining the first input and the output and supporting the primary power path, the first energy storage path, the energy storage device, and the one or more PSUs.

A power delivery apparatus according to any of the proceeding embodiments may also be joined with a computing device so as to form a system in which the power delivery apparatus delivers and manages power that is supplied to the computing device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates an example datacenter installation in accordance with one or more example embodiments of the present disclosure;

FIG. 2 illustrates example computing devices of the datacenter installation of FIG. 1 in accordance with some embodiments described herein;

FIG. 3 is an example graphical illustration of compute power and feed power during performance of one or more operations by the example computing devices of FIG. 2 in accordance with some embodiments described herein;

FIG. 4 illustrates an example power delivery apparatus in accordance with some embodiments described herein;

FIG. 5 illustrates an example power delivery apparatus with redundancy in accordance with some example embodiments described herein;

FIG. 6 illustrates a block diagram of example controller circuitry that may be specifically configured in accordance with an example embodiment of the present disclosure; and

FIG. 7 illustrates a flowchart of an example method for power delivery and management in accordance with some embodiments of the present disclosure.

### DETAILED DESCRIPTION

### Overview

Embodiments of the present disclosure now will be described more fully hereinafter with reference to the accompanying drawings in which some but not all embodiments are shown. Indeed, the present disclosure may be embodied in many different forms and should not be construed as limited to the embodiments set forth herein; rather, these embodiments are provided so that this disclosure will satisfy applicable legal requirements. Like numbers refer to like elements throughout. As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

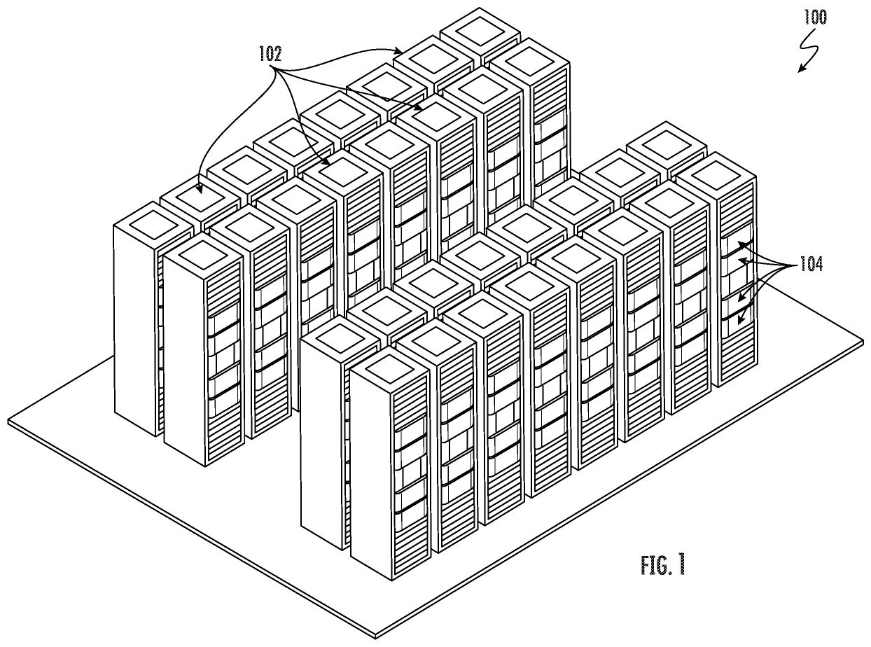

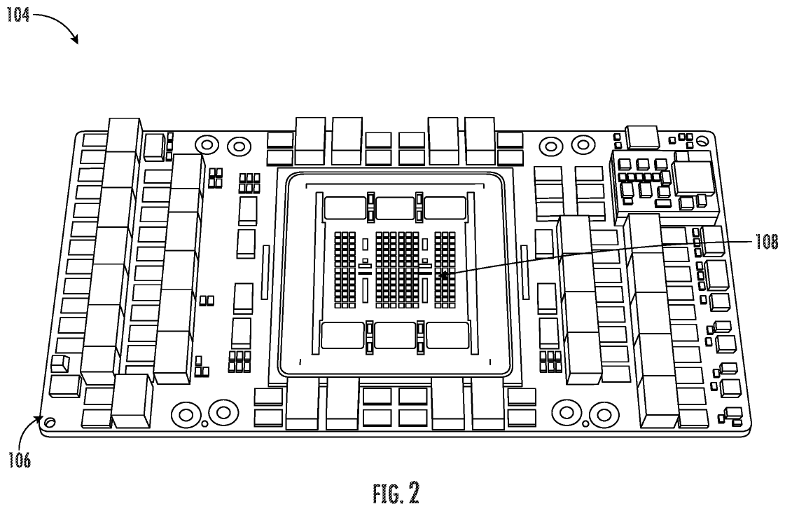

As described above, datacenters and other networking environments (e.g., datacom, telecom, and/or other similar data/communication transmission networks), may leverage numerous electronic or computing components (e.g., CPUs, GPUs, DPUs, memory devices, etc.) to perform the operations associated with these environments. As shown in FIG. 1, for example, an example datacenter installation 100 (e.g., installation 100) is illustrated. Datacenter installations 100, such as those that are employed in high performance computing clusters and/or the like, may be formed of a plurality of datacenter computing components (e.g., central processing units (CPUs), data processing units (DPUs), GPUs, compute racks (e.g., boxes), servers, racks, switches, etc.). As shown, the example datacenter installation 100 may include a plurality of racks 102 supporting or otherwise formed of one or more compute boxes 104 (e.g., servers, computing modules, GPU modules, optoelectronic devices, etc.). As described hereafter with reference to FIG. 2, the example compute boxes 104 may include various electrical components, optical components, computing devices, etc. (e.g., GPUs 108) for performing the operations associated with the datacenter installation 100.

With reference to FIG. 2, an example compute box 104 (e.g., a GPU module) of the present disclosure is illustrated. As shown, the compute box 104 may include a substrate 106 that may support various computing components (e.g., optical components, electrical components, etc.) as described herein. In some embodiments, the substrate 106 may refer to a printed circuit board (PCB) that is configured to at least partially provide physical support to and electrical connectivity between the computing components described herein. As such, the substrate 106 may define one or more electrical traces, wires, etc. configured to establish electrical communication between the computing components, electrical components, optical components, etc. described herein. By way of a non-limiting example, the substrate 106 may support a computing device 108 (e.g., a first computing device 108) that is a graphics processing unit (GPU). Although described herein with reference to a GPU as the computing device 108, the present disclosure contemplates that the power delivery and management apparatuses of the present disclosure may be applicable to any computing device of any type.

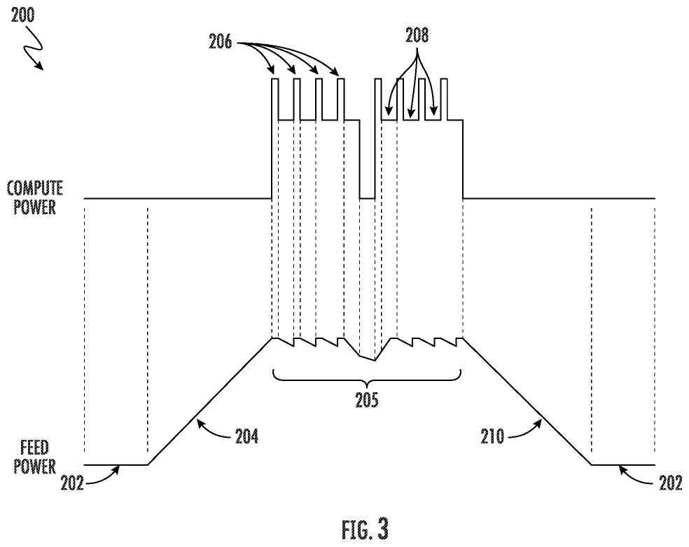

As the number of racks 102 and compute boxes 104 (e.g., GPU modules) for a datacenter installation 100 increases, the energy consumed by the datacenter installation (e.g., the power required by the datacenter installation 100) similarly increases. Additionally, as the complexity or magnitude of the operations performed by the computing devices 108 of the datacenter installation increases, the energy consumed by the plurality of computing devices 108 (e.g., GPUs or the like) similarly increases. With reference to FIG. 3, for example, a graphical illustration 200 of compute power and feed power during performance of one or more operations by the computing device 108 is illustrated. As shown, the computing device 108 may initially be idle 202 in that the feed power is relatively low and compute power remains relatively stable. As the feed power ramps up 204 (e.g., increases), the compute power may remain relatively stable until a high feed power state 205 is reached. When the feed power remains high 205 due to the performance of a particular set of operations (e.g., a job performed by the computing device(s) 108), the compute power of the computing device(s) 108 may vary between relatively high compute power states 206 and relatively low compute power states 208. Following performance of these operations (e.g., completion of the job), the feed power may ramp down 210 to return to an idle condition 202.

The large minimum to maximum power swings for the computing device(s) 108 (e.g., GPUs) as shown in FIG. 3 (e.g., states 206, 208) in conjunction with the increased power levels and computing device count of emerging datacenter installations 100 present dynamic power challenges for the utility systems (e.g., power grids or the like) that supply energy to these installations 100. In particular, the advent of GPU clusters provide unique challenges to utility systems due, at least in part, to the ability for the GPUs (e.g., computing devices 108) to rapidly reach maximum operational capacity relative other computing devices. For example, a cluster of GPUs (e.g., computing devices 108) in a high performance computing application (e.g., a supercomputer or the like) may require fifty (50) or more megawatts of power from the utility systems associated with this application, and this power consumption may increase substantially as the size of the installation scales.

In light of the increased speed at which high performance computing applications reach maximum operating conditions, utility systems (e.g., power grids or the like) are often incapable of quickly and effectively supplying energy to these systems at a similar expediency. For example, a typical power grid may require thirty (30) seconds or longer to respond to an increased draw of electrical energy while the GPUs (e.g., example computing devices 108) may reach maximum operating capacity in fractions of a second. This timing discrepancy may result in insufficient power supplied to GPUs and/or, due to the substantially increased energy burden on the utility systems (e.g., power grids or the like), may result in full or partial failure of the utility systems (e.g., a brownout or blackout of the power grid). Conventional attempts at addressing these issues often rely upon power dissipative solutions. For example, some traditional solutions provide dummy workloads (e.g., fictious loads) to the GPUs (e.g., computing devices 108) and/or employ resistor banks (e.g., a collection of resistors or the like) in order to maintain a constant apparent power level to the grid. These conventional solutions; however, are inherently inefficient in that the artificially increased power level for the GPUs is wasted (e.g., used only to maintain an increased power level as opposed to used by the GPUs to perform valid operations).

In order to address these issues and others, the embodiments of the present disclosure may leverage power delivery apparatuses and systems that include an energy storage device at the computing device (e.g., GPU or the like) level so as to locally store energy. For example, a power delivery apparatus of the present disclosure may include a primary power path and associated first power supply unit (PSU) that may direct power received from a power source (e.g., an associated power grid or otherwise) to a computing device (e.g., GPU). The power delivery apparatus may further include a first energy storage path with an associated energy storage device (e.g., battery, supercapacitor, ultracapacitor, etc.), and a second PSU that directs power received from the power source (e.g., power grid) to the energy storage device for storage. In doing so, the embodiments of the present disclosure may operate to locally store energy in instances in which the GPU does not require excess power (e.g., energy received from the power grid) in order to maintain a requisite power level (e.g., to mitigate power grid ramp up) to the GPUs. Once the GPUs receive an associated job that requires increased power or energy, the energy stored by the energy storage device may be directed to the GPUs (e.g., computing devices) to allow the power provided by the utility systems (e.g., power grid) to reach sufficient power levels. As such, these power delivery and management devices may operate to reduce the energy burden on the associated utility systems (e.g., power grid) and smooth (e.g., reduce the difference between high and low power states) the power input to the GPUs (e.g., computing devices).

### Example Power Delivery Apparatus

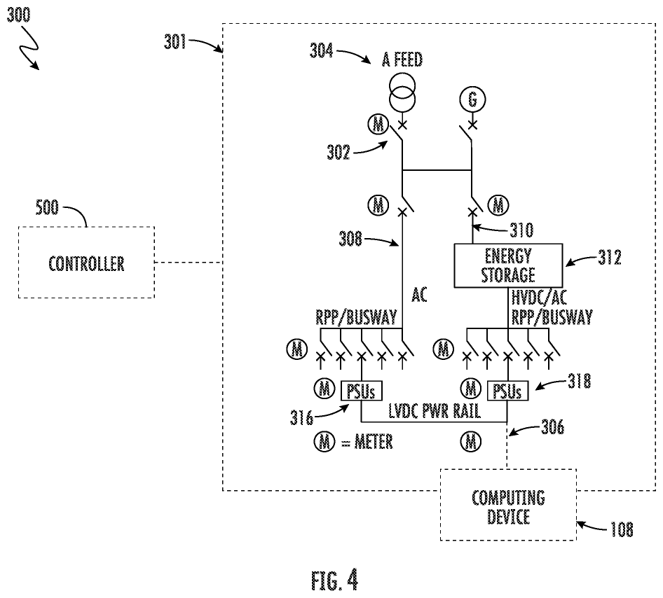

With reference to FIG. 4, an example power delivery apparatus 300 of the present disclosure is illustrated. As shown, the power delivery apparatus 300 may include a first input 302 that may be configured to be electrically coupled with a first power source 304 (e.g., an A feed). As described above, the computing devices 108 (e.g., GPUs) of the present disclosure may be formed as part of a datacenter installation 100 that is powered by (e.g., supplied energy by) an associated utilities service (e.g., power grid or the like). As such, the first power source 304 may refer to a connection with the example power grid for providing energy (e.g., powering) the computing devices 108 described hereinafter. The first input 302 may, therefore, refer to any mechanism or structure by which the power delivery apparatus 300 may be electrically connected or coupled with the first power source 304 (e.g., the A feed). By way of a non-limiting example, the first input 302 may refer to a connector, port, plug, or the like that may be configured to connect the power delivery apparatus 300 with the first power source 304. In some instances, the first input 302 may be directly coupled or connected with the first power source 304. As would be evident to one of ordinary skill in the art in light of the present disclosure, however, the connection between the power delivery apparatus 300 and the first power source 304 (e.g., the A feed) may include any number of intermediary devices, cables, wiring, etc. between the first power source 304 (e.g., the A feed) and the first input 302. Furthermore, although described herein with reference to an example power grid as the first power source 304, the present disclosure contemplates that the power delivery apparatus 300 may be configured to receive power from any type of power source.

The power delivery apparatus 300 may further include an output 306 configured to be electrically coupled with at least a first computing device 108. Similar to the first input 302, the output 306 may refer to any mechanism or structure by which the power delivery apparatus 300 may be electrically connected or coupled with the computing device(s) 108 (e.g., GPU). By way of a non-limiting example, the output 306 may refer to a connector, port, plug, or the like that may be configured to connect the power delivery apparatus 300 with the computing device 108. In some instances, the output 306 may be directly coupled or connected with the computing device(s) 108. As would be evident to one of ordinary skill in the art in light of the present disclosure, however, the connection between the power delivery apparatus 300 and the computing device(s) 108 may include any number of intermediary devices, cables, wiring, etc. between the computing device(s) 108 and the output 306.

In some embodiments, the power delivery apparatus 300 may be formed in conjunction with the computing device 108, such as a system that comprises the computing device 108 and the power delivery apparatus 300. Said differently, the power delivery apparatus 300 of the present disclosure may, in some instances, be combined with the computing device(s) 108 so as to provide an integrated solution. In such an implementation, the output 306 may refer to a connection to the computing device(s) 108 that is internal to the system that comprises the power delivery apparatus 300 and the computing device(s) 108. Although described herein with reference to a computing device 108, the present disclosure contemplates that the computing device 108 may refer to a plurality of computing devices 108 electrically coupled or connected with the power delivery apparatus 300. By way of a non-limiting example, the computing device 108 may refer to a plurality of GPUs (e.g., a GPU cluster) that, alone or in combination, perform various operations of the datacenter installation 100.

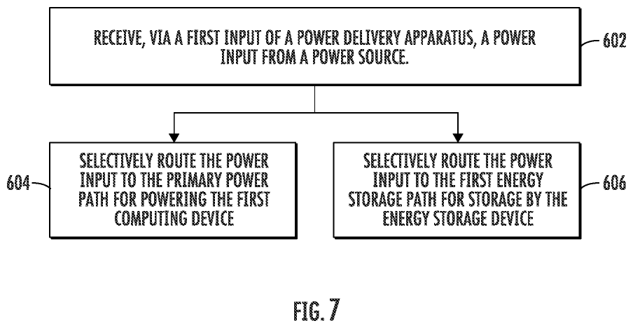

With continued reference to FIG. 4, the power delivery apparatus 300 may include a primary power path 308 electrically coupling the first input 302 and the output 306, and a first energy storage path 310 that electrically couples the first input 302 and the output 306. The primary power path 308 may include any structure for electrically connecting the first input 302 and the output 306. For example, the primary power path 308 may include electrical wires, traces, cables, and/or the like that extend between the first input 302 and the output 306. Similarly, the first energy storage path 310 may include any structure for electrically connecting the first input 302 and the output 306 and may include electrical wires, traces, cables, and/or the like that extend between the first input 302 and the output 306. As described hereinafter, the primary power path 308 and the first energy storage path 310 may operate as distinct pathways between the first input 302 and the output 306 by which electricity (e.g., energy, power, etc.) may travel. As described hereafter with reference to the operations of FIG. 7, the power input (e.g., electrical energy) received by the power delivery apparatus 300 via the first input 302 may be directed by one or more of the primary power path 308 and the first energy storage path 310 to the computing device(s) 108 based upon the power requirements of the computing device(s) 108, the operations performed by the computing device(s) 108, and/or the like.

The power delivery apparatus 300 may further include an energy storage device 312 electrically coupled with the first energy storage path 310. As shown in FIG. 4, the energy storage device 312 may be connected along the first energy storage path 310 (e.g., in electrical communication with the first energy storage path 310) such that power (e.g., electrical energy) that is directed from the first input 302 to the first energy storage path 310 is received by the energy storage device 312. To this end, the energy storage device 312 may be configured to store the energy that is received from the first input 302 via the first energy storage path 310. In some embodiments, the energy storage device 312 may include, alone or in any combination, a battery, a supercapacitor, an ultracapacitor, a fuel cell, an alternate power grid connection, a generator, and/or the like. The present disclosure contemplates that the energy storage device 312 may include any device, structure, apparatus, cell, etc. that may store electrical energy (e.g., at least a portion of the power input received by the power delivery apparatus 300). Although illustrated in FIG. 4 as a single energy storage device 312, the present disclosure contemplates that the energy storage device 312 may include any number of distinct or integrated energy storage devices based upon the intended application of the power delivery apparatus 300, the operational characteristics of the computing device(s) 108, and/or the like.

The power delivery apparatus 300 may further include one or more power supply units (PSUs) 316, 318 electrically coupled with the primary power path 308 and the first energy storage path 310. The one or more PSUs 316, 318 may be configured to selectively route the power (e.g., electrical energy) received via the first input 302 to one or more components described herein. For example, the one or more PSUs 316, 318 may be configured to selectively route power to the primary power path 308 for powering the first computing device(s) 108 and/or to the first energy storage path 310 for storage by the energy storage device 312. As would be evident to one of ordinary skill in the art in light of the present disclosure, a power supply unit may include various circuitry components configured to modify voltage (e.g., increase or decrease the voltage of a received electrical energy input), convert the form of a received power input (e.g., from alternating current (AC) to direct current (DC)), to regulate power for smoother output voltage, etc. In the embodiments of the present application, the PSUs 316, 318 may operate to draw power from the first power source 304 so as to direct power along the primary power path 308 and/or the first energy storage path 310.

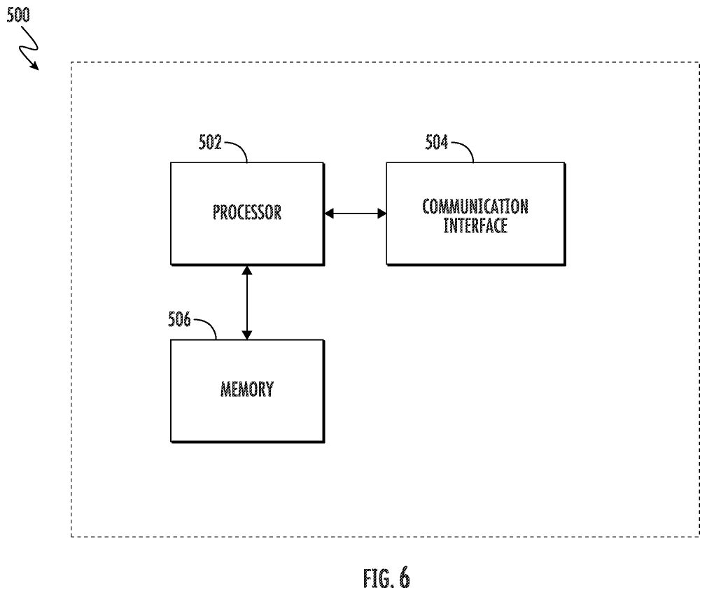

By way of example, the one or more power supply units may include a first PSU 316 electrically coupled with the primary power path 308 and a second PSU 318 electrically coupled with the first energy storage path 310. As described further with reference to FIG. 7, the first PSU 316 may be configured to draw power from the first input 302 (e.g., from the first power source 304) so as to selectively route power to the first computing device 108 via the primary power path 308. The second PSU 318 may be configured to draw power from the first input 302 (e.g., from the first power source 304) so as to selectively route power to energy storage device 312 via the first energy storage path 310. In some instances, the components required to direct the power along the primary power path 308 and/or the first energy storage path 310 may be contained by the first PSU 316 and the second PSU 318, respectively. In other embodiments, as described hereafter with reference to the circuitry components of FIG. 6, the power delivery apparatus 300 may be configured to be operably coupled with a controller 500 that may, in whole or in part, facilitate directing of the power (e.g., electrical energy) received by the power delivery apparatus 300.

In some embodiments, the first PSU 316 may be configured to draw power along the primary power path 308 from the first power source 304 electrically coupled with the first input 302 such that all or substantially all of the power (e.g., electrical energy) received from the first power source 304 is directed to the first PSU 316. In other embodiments, the second PSU 318 may be configured to draw power along the first energy storage path 310 from the first power source 304 electrically coupled with the first input 302 such that all or substantially all of the power (e.g., electrical energy) received from the first power source 304 is directed to the energy storage device 312. In some instances, however, the first PSU 316 and the second PSU 318 may be configured to selectively route power via one or more proportional control operations such that a portion of the power (e.g., electrical energy) received from the first power source 304 is directed along the primary power path 308 and another portion of the power (e.g., electrical energy) received from the first power source 304 is directed along the first energy storage path 312. The present disclosure contemplates that the one or more PSUs described herein may be operable with AC or DC power inputs without limitation and may convert between AC and DC power based upon the intended application of the apparatus 300.

In any embodiment, the power delivery apparatus 300 may include a housing 301 defining the first input 302 and the output 306 and supporting the primary power path 308, the first energy storage path 310, the energy storage device 312, and the one or more PSUs 316, 318. In some instances, this housing 301 may be configured to be connected (e.g., via the output 306) to the computing device(s) 108, such that the power delivery apparatus 300 operates as a separable component or device that may be removably connected with power sources and computing devices. In other embodiments, the housing 310 may be the same housing of the example computing device 108 in that the power delivery apparatus 300 and the computing device 108 are formed as an integrated solution. In any embodiment, the housing 301 may be dimensioned (e.g., sized and shaped) based upon the number and arrangement of the components of the power delivery apparatus 300, the intended application of the apparatus 300, and/or the like.

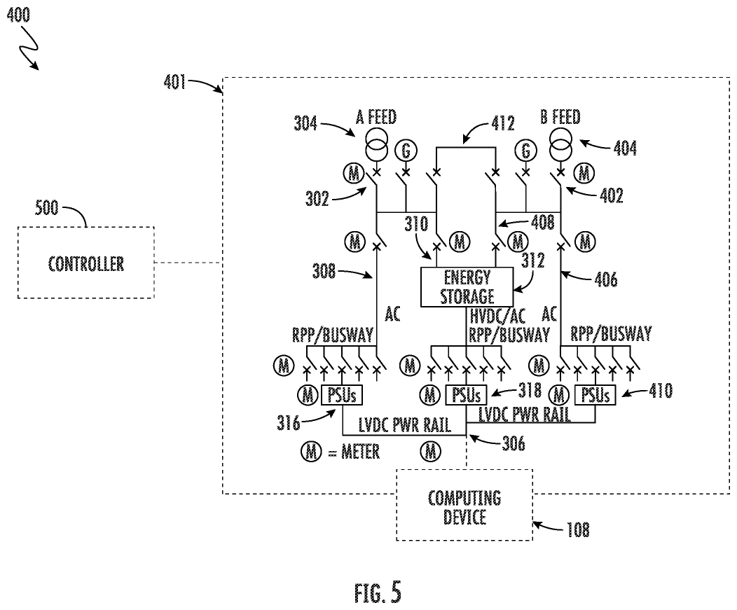

In some embodiments, as shown in FIG. 5, the power delivery apparatuses of the present disclosure may include redundancy features. For example, the power delivery apparatus 400 of FIG. 5 may include the first input 302, the output 306, the primary power path 308, the first energy storage path 310, the energy storage device 312, the first PSU 316, and the second PSU 318 similar to the power delivery apparatus 300 described above with reference to FIG. 4. The power delivery apparatus 400, however, may include a second input 402, a secondary power path 406, a second energy storage path 406, and a third PSU 410.

The second input 402 may be configured to be electrically coupled with a second power source 404 (e.g., a B feed). As described above, the computing devices 108 (e.g., GPUs) of the present disclosure may be formed as part of a datacenter installation that is powered by (e.g., supplied energy by) an associated utilities service (e.g., power grid or the like). As such, the second power source 404 may refer to a connection with the example power grid for providing energy (e.g., powering) the computing devices 108 described hereinafter. In some instances, the second power source 404 (e.g., the B feed) may be associated with the same power grid as the first power source (e.g., the A feed). In other embodiments, the second power source 404 may be distinct from the first power source 304. The second input 404 may refer to any mechanism or structure by which the power delivery apparatus 300 may be electrically connected or coupled with the second power source 404, such as a connector, port, plug, or the like that may be configured to connect the power delivery apparatus 300 with the second power source 404.

With continued reference to FIG. 5, the power delivery apparatus 400 may include a secondary power path 406 electrically coupling the second input 402 and the output 306, and a second energy storage path 408 that electrically couples the second input 402 and the output 306. The secondary power path 406 may include any structure for electrically connecting the second input 302 and the output 306. For example, the secondary power path 406 may include electrical wires, traces, cables, and/or the like that extend between the second input 402 and the output 306. Similarly, the second energy storage path 408 may include any structure for electrically connecting the second input 402 and the output 306 and may include electrical wires, traces, cables, and/or the like that extend between the second input 402 and the output 306. The storage device 312 may also be electrically coupled with the second energy storage path 408. As shown in FIG. 5, the energy storage device 312 may also be connected along the second energy storage path 408 (e.g., in electrical communication with the second energy storage path 408) such that power (e.g., electrical energy) that is directed from the second input 402 to the second energy storage path 408 is received by the energy storage device 312.

The power delivery apparatus 400 may further include one or more power supply units (PSUs) 316, 318, 410 electrically coupled with the primary power path 308, the secondary power path 406, the first energy storage path 310, and the second energy storage path 408. The first PSU 316 may be configured to draw power from the first input 302 as described above with reference to FIG. 4. The second PSU 318 may be configured to draw power from the first input 302 (e.g., from the first power source 304) and from the second input 402 (e.g., form the second power source 404) so as to selectively route power to the energy storage device 312 via the first energy storage path 310 or the second energy storage path 408, respectively. Similar to the first PSU 316, the third PSU 410 may be configured to draw power from the second input 402 (e.g., from the second power source 404) so as to selectively route power to the first computing device 108 via the secondary power path 406. As described above with reference to FIG. 4, the PSUs 316, 318, 410 may leverage proportional control operations such that a portion of the power (e.g., electrical energy) received from the first power source 304 and/or the second power source 404 may be directed along the primary power path 308, the first energy storage path 312, the second energy storage path 408, and/or the secondary power path 406.

In some embodiments, the power delivery apparatus 400 may further include a redundancy power path 412 electrically coupling the first energy storage path 310 and the second energy storage path 408. Such a redundancy power path 412 may operate to allow power that is received from the first input 302 (e.g., from the first power source 304) to be directed to the second energy storage path 408 and/or the secondary power path 406. Additionally, the redundancy power path 412 may operate to allow power that is received from the second input 402 (e.g., from the second power source 404) to be directed to the first energy storage path 310 and/or the primary power path 308. For example, the one or more PSUs 316, 318, 410, alone or in combination, may be configured to selectively route power received via the first input 302 from the first power source 304 to the secondary power path 406 or the second energy storage path 408 or selectively route power received via the second input 402 from the second power source 404 to the primary power path 308 or the first energy storage path 310. In instances in which there is a component failure of the power supply apparatus 400 and/or power failure associated with the first or second power sources 304, 404, the redundancy power path 412 may allow power to be delivered to the energy storage device 312 and/or the computing device(s) 108. Similar to the power delivery apparatus 300, the power delivery apparatus 400 may include a housing 401 that may be configured to support one or more of the components illustrated in FIG. 5.

### Example Controller Circuitry

With reference to FIG. 6, example circuitry components of the controller 500 are illustrated that may, alone or in combination with any of the components described herein, be configured to perform the operations described herein with reference to FIG. 7. By way of example, the controller 500 may be configured to set or modify one or more settings of the example PSUs 316, 318, 410 so as to modify the operations of the associated power delivery apparatuses 300, 400. By way of example, the controller 500 may transmit instructions to the power delivery apparatuses 300, 400 so as to modify the power draw conditions of one or more of the PSUs 316, 318, 410 so as to selectively direct the power inputs received by these apparatuses 300, 400. The present disclosure contemplates that the controller 500 may operate to modify any characteristic, attribute, parameter, condition, etc. associated with the PSUs 316, 318, 410 based upon the intended application or operation of the apparatuses 300, 400.

As shown, the controller 500 may include, be associated with or be in communication with processor 502, a memory 506, and a communication interface 504. The processor 502 may be in communication with the memory 506 via a bus for passing information among components of the controller 500. The memory 506 may be non-transitory and may include, for example, one or more volatile and/or non-volatile memories. In other words, for example, the memory 506 may be an electronic storage device (e.g., a computer readable storage medium) comprising gates configured to store data (e.g., bits) that may be retrievable by a machine (e.g., a computing device like the processing circuitry). The memory 506 may be configured to store information, data, content, applications, instructions, or the like for enabling the apparatus to carry out various functions in accordance with an example embodiment of the present disclosure. For example, the memory 506 could be configured to buffer input data for processing by the processor 502. Additionally or alternatively, the memory 506 could be configured to store instructions for execution by the processor 502.

The controller 500 (e.g., example centralized or separate computing device of the present disclosure) may, in some embodiments, be embodied in various computing devices as described above, such as the one or more PSUs 316, 318, 410. However, in some embodiments, the controller may be embodied as a chip or chip set. In other words, the controller may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 502 may be embodied in a number of different ways. For example, the processor 502 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 502 may be configured to execute instructions stored in the memory 506 or otherwise accessible to the processor 502. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 502 is embodied as an executor of instructions, the instructions may specifically configure the processor to perform the algorithms and/or operations described herein when the instructions are executed. However, in some cases, the processor 502 may be a processor of a specific device configured to employ an embodiment of the present disclosure by further configuration of the processing circuitry by instructions for performing the algorithms and/or operations described herein. The processor 502 may include, among other things, a clock, an arithmetic logic unit (ALU) and logic gates configured to support operation of the processing circuitry.

The communication interface 504 may be any means such as a device or circuitry embodied in either hardware or a combination of hardware and software that is configured to receive and/or transmit data, including media content in the form of video or image files, one or more audio tracks or the like. In this regard, the communication interface 504 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

### Example Methods for Power Delivery and Management

With reference to FIG. 7, a flowchart of an example method for power delivery and management is illustrated. As shown in operation 602, the method may include receiving, by a first input 302 of a power delivery apparatus 300, 400, a power input from a first power source 304. In some embodiments, with reference to the power delivery apparatus 400 of FIG. 5, a power input may also be received by the second input 402 from a second power source 404. Receipt of the power input is described further above with reference to FIGS. 4-5.

As shown in operations 604 and 606, the one or more PSUs 316, 318, 410 may selectively route the power input to the primary power path 308 or the secondary power path 406 for powering the first computing device 108 and may selectively route the power input to the first energy storage path 310 or the second energy storage path 408 for storage by the energy storage device 312. By way of non-limiting example, in an instance in which the computing device 108 is operating at less than maximum capacity, the second PSU 318 may draw power from the first input 302 (e.g., from the first power source 304) and/or draw power from the second input 402 (e.g., from the second power source 404) in order to store energy by the energy storage device 312. This storing of power by the energy storage device 312 may maintain an increased power level to avoid or minimize the ramp up time associated with the power sources 304, 404 (e.g., the power grid or otherwise). Additionally or alternatively, in an instance in which the power input received by the power delivery apparatus 300, 400 from the first power source 304 and/or the second power source 404 is insufficient for the operations of the computing device 108, the power computing device 108 may draw power (e.g., electrical energy) that was previously-stored by the energy storage device 312 to supplement the power received from the power grid (e.g., the first and/or second power sources 304, 404). In doing so, the power delivery apparatus 300, 400 of the present application may avoid wasting power (e.g., electrical energy) as is common in conventional solutions.

In some embodiments, failure to one or more of the components described herein or the power grid may occur. In such an instance, the power delivery apparatus 400 of FIG. 5 may operate as a redundant or resilient connection for providing power (e.g., electrical energy) to the computing device 108. By way of a non-limiting example, the first power source 304 may experience failure such that the computing device 108 is to be powered by the second power source 404. In such an embodiment, the first PSU 316 may draw power from the second power supply 404 via the primary power path 308 and redundancy power path 412. Additionally or alternatively, the third PSU 410 may draw power from the second power source 404 via the secondary power path 406. The present disclosure contemplates that the power delivery apparatuses 300, 400 of the present disclosure may direct power from the first power source 304, the second power source 404, and/or the energy storage device 312 via any of the electrical pathways described herein based upon the intended application of the apparatuses 300, 400, the operating parameters of the computing device 108, etc.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of any optical component or optoelectronic element. In addition, the methods described above may include fewer steps in some cases, while in other cases may include additional steps. Modifications to the steps of the method described above, in some cases, may be performed in any order and in any combination.

Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

That which is claimed is:

1. A power delivery apparatus comprising:
a first input configured to be electrically coupled with a first power source;
an output configured to be electrically coupled with at least a first computing device;
a primary power path electrically coupling the first input and the output;
a first energy storage path electrically coupling the first input and the output;
an energy storage device electrically coupled with the first energy storage path and configured to store energy; and
one or more power supply units (PSUs) electrically coupled with the primary power path and the first energy storage path and configured to selectively route power received via the first input from the first power source to:
the primary power path for powering the first computing device; or
the first energy storage path for storage by the energy storage device.

2. The power delivery apparatus according to claim 1, wherein the one or more PSUs further comprise:
a first PSU electrically coupled with the primary power path; and
a second PSU electrically coupled with the first energy storage path.

3. The power delivery apparatus according to claim 2, wherein:
the first PSU is configured to draw power from the first input so as to selectively route power to the first computing device via the primary power path; and
the second PSU is configured to draw power from the first input so as to selectively route power to the energy storage device via the first energy storage path.

4. The power delivery apparatus according to claim 3, wherein the first PSU and the second PSU are configured to selectively route power via one or more proportional control operations.

5. The power delivery apparatus according to claim 1, wherein the first computing device is a graphics processing unit (GPU).

6. The power delivery apparatus according to claim 1, wherein the energy storage device comprises one or more of a battery, a supercapacitor, an ultracapacitor, a fuel cell, an alternate power grid connection, or a generator.

7. The power delivery apparatus according to claim 1, further comprising:
a second input configured to be electrically coupled with a second power source;
a secondary power path electrically coupling the second input and the output; and
a second energy storage path electrically coupling the second input and the output, wherein the one or more PSUs are further electrically coupled with the second energy storage path and the secondary power path and configured to selectively route power received via the second input from the second power source to:
the secondary power path for powering the first computing device; or
the second energy storage path for storage by the energy storage device.

8. The power delivery apparatus according to claim 7, wherein the one or more PSUs further comprise:
a first PSU electrically coupled with the primary power path;
a second PSU electrically coupled with the first energy storage path and the second energy storage path; and
a third PSU electrically coupled with the secondary power path.

9. The power delivery apparatus according to claim 8, wherein:
the first PSU is configured to draw power from the first input so as to selectively route power to the first computing device via the primary power path;
the second PSU is configured to:
draw power from the first input so as to selectively route power to the energy storage device via the first energy storage path; and
draw power from the second input so as to selectively route power to the energy storage device via the second energy storage path; and
the third PSU is configured to draw power from the second input so as to selectively route power to the first computing device via the secondary power path.

10. The power delivery apparatus according to claim 8, further comprising a redundancy power path electrically coupling the first energy storage path and the second energy storage path.

11. The power delivery apparatus according to claim 10, wherein the one or more PSUs are further configured to:
selectively route power received via the first input from the first power source to:
the secondary power path; or
the second energy storage path; or
selectively route power received via the second input from the second power source to:
the primary power path; or
the first energy storage path.

12. The power delivery apparatus according to claim 1, further comprising a housing defining the first input and the output and supporting the primary power path, the first energy storage path, the energy storage device, and the one or more PSUs.

13. A method for power delivery and management, the method comprising:
receiving, via a first input of a power delivery apparatus, a power input from a first power source; and
selectively routing, by one or more power supply units (PSUs), the power input to:
a primary power path for powering a first computing device; or
a first energy storage path for storage by an energy storage device.

14. The method according to claim 13, wherein the power delivery apparatus comprises:
an output configured to be electrically coupled with at least the first computing device;
the primary power path electrically coupling the first input and the output;
the first energy storage path electrically coupling the first input and the output;
the energy storage device electrically coupled with the first energy storage path and configured to store energy; and
the one or more PSUs electrically coupled with the primary power path and the first energy storage path.

15. The method according to claim 14, wherein the one or more PSUs further comprise:
a first PSU electrically coupled with the primary power path; and
a second PSU electrically coupled with the first energy storage path.

16. The method according to claim 15, wherein:
the first PSU is configured to draw power from the first input so as to selectively route power to the first computing device via the primary power path; and
the second PSU is configured to draw power from the first input so as to selectively route power to the energy storage device via the first energy storage path.

17. The method according to claim 16, wherein the first PSU and the second PSU are configured to selectively route power via one or more proportional control operations.

18. The method according to claim 14, wherein the first computing device is a graphics processing unit (GPU).

19. The method according to claim 14, wherein the energy storage device comprises one or more of a battery, a supercapacitor, an ultracapacitor, a fuel cell, an alternate power grid connection, or a generator.

20. A system comprising:
a computing device; and
a power delivery apparatus comprising:
a first input configured to be electrically coupled with a first power source;
an output electrically coupled with at least a first computing device;
a primary power path electrically coupling the first input and the output;
a first energy storage path electrically coupling the first input and the output;
an energy storage device electrically coupled with the first energy storage path and configured to store energy; and
one or more power supply units (PSUs) electrically coupled with the primary power path and the first energy storage path and configured to selectively route power received via the first input from the first power source to:
the primary power path for powering the first computing device; or
the first energy storage path for storage by the energy storage device.
